(19) United States
(12) Patent Application Publication
(10) Pub. No.: US 2023/0174093 A1
(43) Pub. Date: Jun. 8, 2023

(54) DRIVING ASSISTANCE DEVICE

(71) Applicants: DENSO CORPORATION, Kariya-city (JP); TOYOTA JIDOSHA KABUSHIKI KAISHA, Toyota-shi (JP)

(72) Inventors: Tomohiko INOUE, Kariya-city (JP); Youhei MASUI, Kariya-city (JP); Hiroaki NIINO, Kariya-city (JP); Toshihiro MARUYAMA, Nagakute-shi (JP); Shota KUROKI, Toyota-shi (JP)

(21) Appl. No.: 18/160,962

(22) Filed: Jan. 27, 2023

Related U.S. Application Data
(63) Continuation of application No. PCT/JP2021/026808, filed on Jul. 16, 2021.

(30) Foreign Application Priority Data
Jul. 30, 2020 (JP) 2020-129542

(51) Int. Cl. B60W 50/14; B60W 30/095; B60W 40/04; B60W 40/06

(52) U.S. Cl. CPC B60W 50/14; B60W 30/0956; B60W 40/04; B60W 40/06; B60W 2050/143; B60W 2050/146; B60W 2554/404

(57) ABSTRACT

A driving assistance device includes: a stoppage factor determination unit configured to determine whether to clear a stoppage factor of the own vehicle,; an interfering object determination unit configured to determine whether an interfering object is present that interferes with the starting of the own vehicle, based on object information of another object that has not been recognized as the stoppage factor; and a notification determination unit configured to: set, as a condition for permitting the provision of a notification for prompting the starting of the own vehicle being stopped, a determination that the stoppage factor is cleared made by the stoppage factor determination unit, and suppress the provision of the notification in response to the interfering object determination unit determining that the interfering object is present even if the stoppage factor determination unit determines that the stoppage factor is cleared during stoppage of the own vehicle.

### CROSS-REFERENCE TO RELATED APPLICATION

The present application is a continuation application of International Application No. PCT/JP2021/026808, filed on Jul. 16, 2021, which claims priority to Japanese Patent Application No. 2020-129542 filed on Jul. 30, 2020. The contents of these applications are incorporated herein by reference in their entirety.

### BACKGROUND

### Technical Field

The present disclosure relates to a driving assistance device that renders driving assistance to an own vehicle based on information on objects in the surroundings of the own vehicle.

### Background Art

There is known a driving assistance device that notifies the own vehicle stopped by a traffic light or the like that the own vehicle has become allowed to start due to a change in the traffic light. The driving assistance device determines whether to provide notification of a change in the traffic light, based on the presence or absence of an occupant in the passenger’s seat, hands-on-wheel detection information, whether the driver is watching the traffic light, and the presence or absence of a vehicle behind the own vehicle, in order to avoid the driver in the own vehicle from feeling uncomfortable about the provision of the notification of a change in the traffic light even when the driver purposefully does not watch the traffic light

### SUMMARY

In the present disclosure, provided is a driving assistance device as the following.

The driving assistance device includes: a stoppage factor determination unit configured to determine whether to clear a stoppage factor of the own vehicle; an interfering object determination unit configured to determine whether an interfering object is present that interferes with starting of the own vehicle; and a notification determination unit configured to set, as a condition for permitting provision of a notification for prompting the starting of the own vehicle being stopped, a determination that the stoppage factor is cleared made by the stoppage factor determination unit, and suppress the provision of the notification for prompting the starting of the own vehicle in response to the interfering object determination unit determining that the interfering object is present even if the stoppage factor determination unit determines that the stoppage factor is cleared during stoppage of the own vehicle.

### BRIEF DESCRIPTION OF THE DRAWINGS

The above-described and other objectives, features, and advantages of the present disclosure will become more clearly by the detailed description below with reference to the accompanying drawings. The drawings are as follows:

FIG. 1 is a diagram illustrating components of a driving assistance system including a driving assistance device installed in a vehicle according to a first embodiment;

FIG. 2 is a flowchart of a notification determination process according to the first embodiment;

FIG. 3 is a diagram describing a stoppage factor recognized by a preceding vehicle determination unit and an interfering object determination;

FIG. 4 is a diagram describing a stoppage factor recognized by a traffic light determination unit and an interfering object determination;

FIG. 5 is a diagram describing a stoppage factor recognized by a railroad crossing determination unit and an interfering object determination;

FIG. 6 is a detailed flowchart of an interfering object determination process according to a second embodiment;

FIG. 7 is a diagram illustrating an example of setting an interfering object detection area based on driving information of an own vehicle;

FIG. 8 is a diagram illustrating an example of setting an interfering object detection area based on road information of the own vehicle;

FIG. 9 is a diagram describing an interfering object determination on a moving object that is detected outside the interfering object detection area;

FIG. 10 is a diagram describing an example of a non-interfering object that is detected inside the interfering object detection area;

FIG. 11 is a diagram describing an example of a non-interfering object that is detected inside the interfering object detection area;

FIG. 12 is a diagram describing a stoppage factor clearance determination in a case where a preceding vehicle recognized as a stoppage factor is closer than a traffic light;

FIG. 13 is a diagram describing a case where there is acquired information suggesting a possibility of a vehicle intruding into a road on which the own vehicle is running on a side closer to the own vehicle than a traffic light recognized as a stoppage factor;

FIG. 14 is a diagram describing a stoppage factor clearance determination in a case where a traffic light recognized as a stoppage factor is closer than a preceding vehicle;

FIG. 15 is a diagram illustrating an example of setting an interfering object detection area according to a modification example; and

FIG. 16 is a flowchart of a notification determination process according to the modification example.

### DETAILED DESCRIPTION OF THE PREFERRED EMBODIMENTS

### PTL 1 Japanese Patent No. 4438583

If the notification is provided when the traffic light has changed from a stop signal to a go signal as described in PTL 1, there is concern that when the own vehicle is started in response to this notification, the own vehicle may encounter a dangerous situation such as a collision with an object existing between the traffic light and the own vehicle. In the technique of PTL 1, the notification is provided with consideration given to information seemingly useful for avoiding driver discomfort, but with no consideration given to information on objects that may interfere with safe starting of the own vehicle.

In view of the foregoing circumstances, an object of the present disclosure is to provide a driving assistance device that is capable of providing a notification for prompting starting of the own vehicle with consideration given to safety.

The present disclosure provides first and second driving assistance devices that render driving assistance to an own vehicle, based on information on an object in surroundings of the own vehicle. The first driving assistance device includes: a stoppage factor determination unit configured to determine whether to clear a stoppage factor of the own vehicle, based on object information on an object that has been recognized as the stoppage factor of the own vehicle; an interfering object determination unit configured to determine whether an interfering object is present that interferes with starting of the own vehicle, based on object information of another object that has not been recognized as the stoppage factor; and a notification determination unit configured to: set, as a condition for permitting provision of a notification for prompting starting of the own vehicle being stopped, a determination that the stoppage factor is cleared made by the stoppage factor determination unit, and suppress the provision of the notification for prompting the starting of the own vehicle in response to the interfering object determination unit determining that the interfering object is present even if the stoppage factor determination unit determines that the stoppage factor is cleared during stoppage of the own vehicle.

In the first driving assistance device of the present disclosure, the notification determination unit is configured to set, as the condition for permitting the provision of the notification for prompting the starting of the own vehicle being stopped, the determination made by the stoppage factor determination unit that the stoppage factor is cleared. The first driving assistance device also includes the interfering object determination unit to determine whether an interfering object is present that interferes with the starting of the own vehicle, based on the object information of the other object having not been recognized as the stoppage factor. The notification determination unit is configured to suppress the provision of the notification for prompting for the starting of the own vehicle in response to the interfering object determination unit determining that the interfering object is present even if the stoppage factor determination unit determines that the stoppage factor is cleared during stoppage of the own vehicle. According to the first driving assistance device, it is possible to suppress the provision of the notification for prompting the starting of the own vehicle, even if the condition for permitting the provision of the notification for prompting the starting of the own vehicle is satisfied, if the own vehicle is in a situation where there is concern that the own vehicle may not be started safely, judging from the result of the determination by the interfering object determination unit. This makes it possible to implement the provision of the notification for prompting the starting of the own vehicle with consideration given to safety.

The second driving assistance device provided in the present disclosure includes: a stoppage factor determination unit configured to determine whether to clear a stoppage factor of the own vehicle, based on object information of an object that has been recognized as the stoppage factor of the own vehicle; an interfering object determination unit configured to determine whether an interfering object is present that interferes with starting of the own vehicle, based on object information on another object that has not been recognized as the stoppage factor; and a notification determination unit configured to: set, as a condition for permitting provision of a notification for prompting starting of the own vehicle being stopped, a determination that the stoppage factor is cleared made by the stoppage factor determination unit, and withhold the provision of the notification for prompting the starting of the own vehicle for a predetermined withhold time in response to the interfering object determination unit determining that the interfering object is present even if the stoppage factor determination unit determines that the stoppage factor is cleared during stoppage of the own vehicle, and provide the notification in response to the interfering object being no longer present and the stoppage factor being cleared before a lapse of the predetermined withhold time.

According to the second driving assistance device, it is possible to withhold the provision of the notification for prompting the starting of the own vehicle, if the own vehicle is in a situation where there is concern that the own vehicle may not be started safely, judging from the result of the determination by the interfering object determination unit, even if the condition for permitting the provision of the notification for prompting the starting of the own vehicle is satisfied. This makes it possible to implement the provision of the notification for prompting the starting of the own vehicle with consideration given to safety.

### First Embodiment

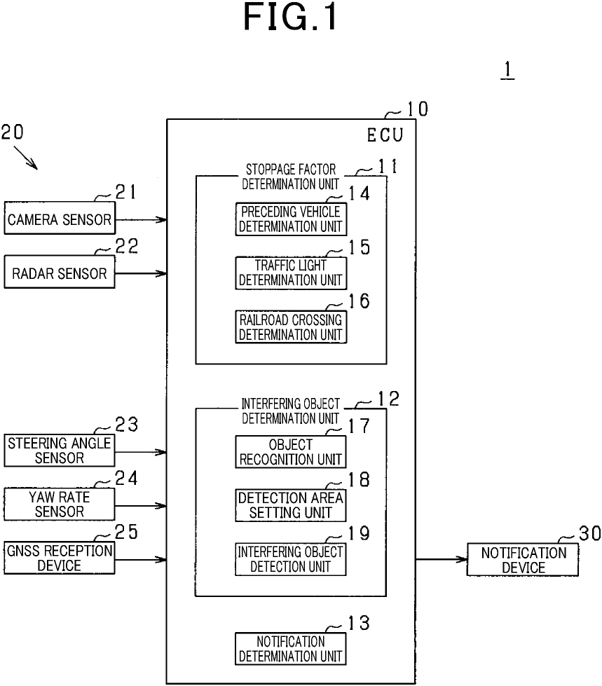

FIG. 1 illustrates a driving assistance system according to the present embodiment. The driving assistance system is installed in a vehicle and includes an ECU 10, a sensor group 20, and a notification device 30.

The sensor group 20 includes a camera sensor 21, a radar sensor 22, a steering angle sensor 23, a yaw rate sensor 24, and a GNSS reception device 25.

The camera sensor 21 and the radar sensor 22 are examples of object detection sensors that acquire information on the surrounding of an own vehicle. Besides, the object detection sensors may include an ultrasonic sensor and a sensor that transmits exploration waves such as a Light Detection and Ranging/Laser Imaging Detection and Ranging (LIDAR).

The camera sensor 21 may be a monocular camera such as a CCD camera, a CMOS image sensor, or a near infrared ray camera, for example, or may be a stereo camera. One or more camera sensors 21 may be installed in the own vehicle. The camera sensor 21 is attached at a predetermined height to the center of the vehicle in the vehicle width direction, and captures an image of a region extending in a predetermined angular range ahead of the vehicle from an overhead point of view. The camera sensor 21 extracts feature points indicating the presence of an object in the captured image. Specifically, the camera sensor 21 extracts edge points based on brightness information of the captured image and performs Hough transformation on the extracted edge points. In Hough transformation, for example, a plurality of edge points consecutively aligning on a straight line or points at which straight lines are orthogonal to each other are extracted as feature points. The camera sensor 21 outputs sequentially captured images as sensing information in sequence to the ECU 10.

The radar sensor 22 is a publicly known millimeter wave radar that transmits highfrequency signals in a millimeter waveband, for example. One or more radar sensors 22 may be installed in the vehicle. The radar sensor 22 is provided at the front end portion of the own vehicle, has a detection range in which an object is detectable at a predetermined detection angle, and detects the position of the object in the detection range. Specifically, the radar sensor 22 transmits exploration waves in predetermined cycles, and receives reflection waves by a plurality of antennas. The distance to the object can be calculated from the transmission time of the exploration wave and the reception time of the reflection wave. The radar sensor 22 also calculates a relative speed by a frequency of the reflection wave reflected by the object that has been changed due to the Doppler effect. In addition, the radar sensor 22 can calculate the azimuth of the object by a phase difference among the reflection waves received by the plurality of antennas. If the position and azimuth of the object can be calculated, the relative position of the object to the own vehicle can be specified.

A millimeter wave radar such as the radar sensor 22, a sonar, and a sensor transmitting exploration waves such as a LIDAR sequentially output the results of scanning based on reception signals obtained by receiving reflection waves reflected from an obstacle, as sensing information, to the ECU 10.

The above-described various object detection sensors may detect not only objects ahead of the own vehicle but also objects behind the own vehicle or on the lateral sides of the own vehicle, and may use the detection results as position information. Depending on the type of the object detection sensor to be used, the target objects to be monitored may be changed. For example, in the case of using the camera sensor 21, the target objects are preferably stationary objects such as road signs and buildings. In the case of using the radar sensor 22, the target objects are preferably objects with high reflected power. The object detection sensors to be used may be selected in accordance with the types, positions, and moving speeds of the target objects. The object detection sensors are not limited to the above-mentioned object detection sensors, and may be any sensor devices that can acquire information in the surroundings of the own vehicle and position information by detecting objects around the own vehicle.

The steering angle sensor 23 is attached to the steering rod of the vehicle, for example, to output to the ECU 10 a steering angle signal in accordance with a change in the steering angle of the steering wheel operated by the driver. The yaw rate sensor 24 outputs to the ECU 10 a yaw rate signal in accordance with the speed of change in the steering amount of the own vehicle.

The GNSS reception device 25 is a device that can receive global navigation satellite system (GNSS) signals, and can receive positioning signals from a satellite positioning system that determines the current position of an object on the ground using artificial satellites. Examples of the GNSS reception device 25 include a GPS reception device that calculates the position information of the own vehicle by receiving GPS signals from the GPS satellite. The GNSS reception device 25 receives positioning signals in predetermined cycles. The GNSS reception device 25 can calculate the position information of the own vehicle based on the received positioning signals and the like. Receiving positioning signals in sequence by the GNSS reception device 25 allows sequential positioning of the own vehicle.

The notification device 30 is actuated in response to a control command from the ECU 10. The notification device 30 may be further actuated in response to an operation input by the driver. In this case, the operation input by the driver may be appropriately processed by the ECU 10, and then input to the notification device 30 as a control command to the ECU 10.

The notification device 30 is a device that provides an aural or visual notification to the driver and the like, and is a speaker, buzzer, display, or the like installed in the interior of the own vehicle, for example. The notification device 30 is capable of providing a notification to the driver for prompting the starting of the own vehicle by issuing a warning sound or displaying a warning message in response to a control command from the ECU 10.

The ECU 10 includes a stoppage factor determination unit 11, an interfering object determination unit 12, and a notification determination unit 13. The stoppage factor determination unit 11 determines whether to clear a stoppage factor of the own vehicle, based on the object information of the object having been recognized as the stoppage factor of the own vehicle. The interfering object determination unit 12 determines whether an interfering object is present that interferes with the starting of the own vehicle, based on the object information of another object that has not been recognized as a stoppage factor. The notification determination unit 13 can refer to the result of the determination by the stoppage factor determination unit 11 and the result of the determination by the interfering object determination unit 12, and determines whether to provide a notification for prompting the starting of the own vehicle, based on these results of the determinations.

The ECU 10 includes a CPU, a ROM, a RAM, an I/O, and the like, and implements these functions by the CPU executing programs installed in the ROM. Accordingly, the ECU 10 generates and outputs a control command to the notification device 30 based on the information acquired from the sensor group 20, and functions as a driving assistance device that renders driving assistance to the own vehicle.

The stoppage factor determination unit 11 determines whether the detected object is a stoppage factor, based on the type, position, speed, state, and the like of the object. The stoppage factor determination unit 11 includes a preceding vehicle determination unit 14, a traffic light determination unit 15, and a railroad crossing determination unit 16.

The preceding vehicle determination unit 14 recognizes a preceding vehicle ahead of the own vehicle as a stoppage factor, and determines whether to clear the stoppage factor based on the object information of the preceding vehicle. For example, if the type of the object detected in the traveling direction of the own vehicle is a vehicle, when the preceding vehicle determination unit 14 judges that the vehicle can become a factor contributing to stoppage of the own vehicle 40 from the position and speed of the vehicle, the preceding vehicle determination unit 14 recognizes the vehicle as a preceding vehicle serving as a stoppage factor. Then, if the object information of the preceding vehicle having been recognized as the stoppage factor is changed and the preceding vehicle determination unit 14 determines that the preceding vehicle can no longer become the stoppage factor, the preceding vehicle determination unit 14 determines that the stoppage factor is to be cleared.

The traffic light determination unit 15 recognizes a traffic light that is present in the traveling direction of the own vehicle as a stoppage factor, and determines whether to clear the stoppage factor based on the object information of the traffic light. For example, if the type of the object detected in the traveling direction of the own vehicle is a traffic light, when the traffic light determination unit 15 judges that the traffic light can become a factor contributing to stoppage of the own vehicle 40 from the position of the traffic light and the state of the signal indicated by the traffic light, the traffic light determination unit 15 recognizes that the traffic light as a stoppage factor. Then, if the object information of the traffic light having been recognized as the stoppage factor is changed and the traffic light determination unit 15 determines that the traffic light can no longer become the stoppage factor, the traffic light determination unit 15 determines that the stoppage factor is cleared.

The railroad crossing determination unit 16 recognizes a railroad crossing that is present in the traveling direction of the own vehicle as a stoppage factor, and determines that the stoppage factor is to be cleared based on the object information of the railroad crossing. For example, if the type of the object detected in the traveling direction of the own vehicle is a railroad crossing, when the railroad crossing determination unit 16 judges that the railroad crossing can become a factor contributing to stoppage of the subject vehicle 40 from the position of the railroad crossing and the states of the crossing bar and alarm, the railroad crossing determination unit 16 recognizes the railroad crossing as a stoppage factor. If the object information of the railroad crossing having been recognized as the stoppage factor is changed and the railroad crossing determination unit 16 determines that the railroad crossing can no longer become the stoppage factor, the railroad crossing determination unit 16 determines that the stoppage factor is cleared.

The stoppage factor determination unit 11 determines whether to clear the stoppage factor, basically based on the results of the determinations on the clearance of the stoppage factor made by the preceding vehicle determination unit 14, the traffic light determination unit 15, and the railroad crossing determination unit 16, respectively. The stoppage factor determination unit 11 may determine that the stoppage factor is cleared on the condition that there is no uncleared stoppage factor determined by any of the preceding vehicle determination unit 14, the traffic light determination unit 15, and the railroad crossing determination unit 16. Otherwise, the stoppage factor determination unit 11 may determine the priority order of the results of determinations by the preceding vehicle determination unit 14, the traffic light determination unit 15, and the railroad crossing determination unit 16, and set a maximum-priority determination result as the determination result of the stoppage factor determination unit 11. Furthermore, under a predetermined condition, the stoppage factor determination unit 11 may be capable of determining that the stoppage factor is not cleared, regardless of the results of determinations that the stoppage factor is to be cleared, made by the preceding vehicle determination unit 14, the traffic light determination unit 15, and the railroad crossing determination unit 16, respectively.

The interfering object determination unit 12 includes an object recognition unit 17, a detection area setting unit 18, and an interfering object detection unit 19.

The object recognition unit 17 performs object recognition based on information on the objects in the surroundings of the own vehicle acquired from the camera sensor 21 and the radar sensor 22. Specifically, using the feature points acquired from the camera sensor 21 and the position information of an object acquired from the radar sensor 22, the object recognition unit 17 recognizes that the object is present at the position. The object recognition unit 17 also associates the relative position and relative speed with respect to the own vehicle for each object. Based on the associated relative position and relative speed, the object recognition unit 17 calculates the lateral speed that is a relative speed in a direction orthogonal to the traveling direction of the own vehicle and the longitudinal speed that is a relative speed in the traveling direction of the own vehicle. The object recognition unit 17 also determines the type of the detected object, based on image information acquired from the camera sensor 21 and dictionary information prepared in advance for identification of target objects.

The detection area setting unit 18 sets an interfering object detection area in which interfering objects are detected, based on the possibility of a collision between objects around the own vehicle which detects interfering objects and the own vehicle. The detection area setting unit 18 is preferably configured to set the interfering object detection area, based on at least one of driving information on the driving state of the own vehicle, road information of the road on which the own vehicle is running, and the object information of an object recognized as a stoppage factor. Setting the interfering object detection area based on these types of information makes it possible to set the appropriate interfering object detection area in accordance with the situations of the own vehicle and the surroundings of the own vehicle.

The interfering object detection unit 19 determines that an interfering object is present if another object having not been recognized as a stoppage factor is detected in the interfering object detection area. Narrowing the detection of an interfering object down to the interfering object detection area reduces the load of the interfering object detection process and allows immediate determination on the notification. On the other hand, the interfering object detection unit 19 may be capable of determining whether there is a possibility that an object detected outside the interfering object detection area may intrude into the interfering object detection area, based on the position, moving amount, or speed of the object. The interfering object detection unit 19 may also be configured to, if any object that may intrude into the interfering object detection area is detected, determine that an interfering object is present.

The notification determination unit 13 sets two absolute conditions for permitting the provision of a notification for prompting the starting of the own vehicle being stopped: the stoppage factor determination unit 11 determines that the stoppage factor is cleared; and the interfering object determination unit 12 does not determine that an interfering object is present. If the stoppage factor determination unit 11 determines that the stoppage factor is cleared and the interfering object determination unit 12 does not determine that an interfering object is present, the notification determination unit 13 determines that the notification is provided without suppression. In this case, the notification determination unit 13 outputs a control command for providing a normal notification to the notification device 30, and the notification device 30 provides the normal notification.

If the stoppage factor determination unit 11 determines that the stoppage factor is cleared during the stoppage of the own vehicle but the interfering object determination unit 12 determines that an interfering object is present, the notification determination unit 13 determines that the provision of the notification for prompting the starting of the own vehicle is suppressed. The suppression of provision of the notification conceptually includes reducing the degree of the notification to be lower than usual, for example, such as turning down a notification sound or decreasing the number of means for making a notification, if there is a plurality of means, and ceasing the provision of the notification. Herein, the suppression of provision of the notification may be simply referred to as the suppression of the notification. The notification determination unit 13 may be capable of executing a process of withholding the provision of the notification before a process of providing or suppressing the notification. Herein, the withholding of provision of the notification may be simply referred to as the withholding of the notification. The notification determination unit 13 may be configured to output a control signal indicating the suppression of provision of the notification to the notification device 30, or may be configured not to output a control command to the notification device 30 in the case of providing no notification.

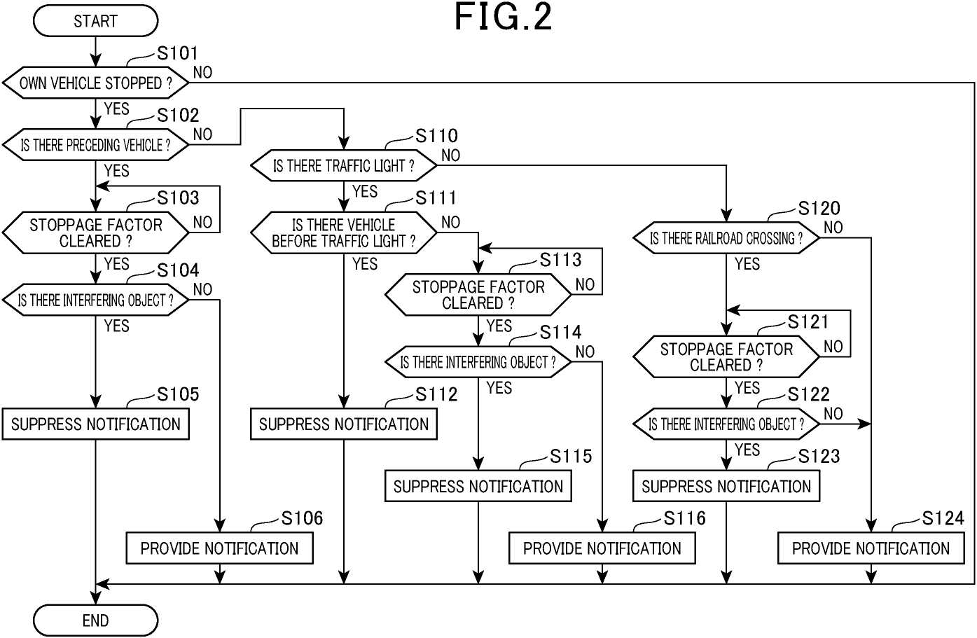

FIG. 2 is a flowchart of a notification determination process performed by the ECU 10. The process illustrated in FIG. 2 is repeatedly executed in predetermined cycles.

First, in step S101, the ECU 10 determines whether the own vehicle is stopped. If the own vehicle is stopped, the process proceeds to step S102. If the own vehicle is not stopped, the process is ended.

In step S102, the ECU 10 determines whether a preceding vehicle recognized as a stoppage factor is present, based on information on objects in the surroundings of the own vehicle acquired from the camera sensor 21 and the radar sensor 22.

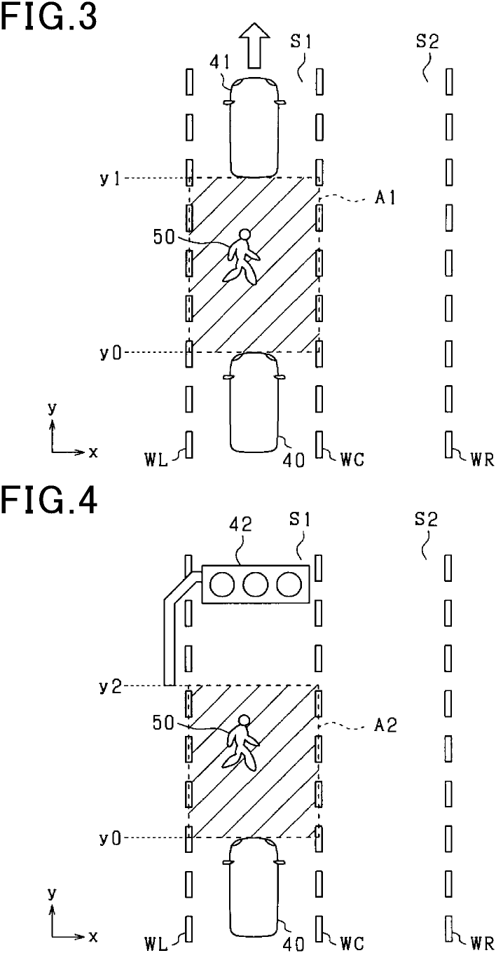

As illustrated in FIG. 3, while an own vehicle 40 is running in a positive direction of a y axis on a lane S1 between a white line WL and a white line WC, if a preceding vehicle 41 stopped on the lane S1 in the traveling direction of the own vehicle 40 (positive direction of the y axis) is present, it can be estimated that the own vehicle 40 will stop due to the existence of the preceding vehicle 41 stopped in the traveling direction of the lane S1. Accordingly, the ECU 10 recognizes the preceding vehicle 41 as a stoppage factor. As a result, the ECU 10 makes an affirmative determination in step S102, and the process proceeds to step S103. If the preceding vehicle 41 recognized as a stoppage factor is not present, the ECU 10 makes a negative determination in step S102, and the process proceeds to step S110.

In step S103, the ECU 10 determines whether the preceding vehicle recognized as a stoppage factor in step S102 has been released from being the stoppage factor. For example, referring to FIG. 3, when the preceding vehicle 41 having been recognized as a stoppage factor is started, the preceding vehicle 41 is released from being the stoppage factor. As a result, the ECU 10 makes an affirmative determination in step S103, and the process proceeds to step S104. For example, if the preceding vehicle 41 recognized as a stoppage factor has not been released from being the stoppage factor due to the continuance of stoppage, the ECU 10 makes a negative determination in step S103. The ECU 10 repeats the determination in step S103 until the ECU 10 makes an affirmative determination.

In step S104, the ECU 10 determines whether an interfering object is present that interferes with the starting of the own vehicle. For example, as illustrated in FIG. 3, in the lane S1, the area between a rear end position yl of the preceding vehicle 41 (end portion as seen in the negative direction of the y axis) and a front end position y0 of the own vehicle 40 (end portion as seen in the positive direction of the y axis) is set as an interfering object detection area A1. The ECU 10 determines whether an object is present in the interfering object detection area A1. If an interfering object 50 (a pedestrian in FIG. 3) is detected in the interfering object detection area A1, the ECU 10 makes an affirmative determination in step S104, and the process proceeds to step S105. In step S105, the ECU 10 determines that the notification is suppressed, and the process is ended. If no interfering object is detected in the interfering object detection area A1, the ECU 10 makes a negative determination in step S104, and the process proceeds to step S106. In step S106, the ECU 10 determines that the notification is provided, and the process is ended.

In step S110, the ECU 10 determines whether a traffic light having been recognized as a stoppage factor is present, based on information on the objects in the surroundings of the own vehicle acquired from the camera sensor 21 and the radar sensor 22.

As illustrated in FIG. 4, while the own vehicle 40 is running in the lane S1 in the positive direction of the y axis, if a traffic light 42 indicates the stop signal (red signal) to vehicles running in the lane S1 in the traveling direction of the own vehicle 40, it can be estimated that the own vehicle 40 will stop due to the stop signal indicated by the traffic light 42. Accordingly, the traffic light 42 is recognized as a stoppage factor. As a result, the ECU 10 makes an affirmative determination in step S110, and the process proceeds to step S111. If the traffic light 42 having been recognized as a stoppage factor is not present, the ECU 10 makes a negative determination in step S110, and the process proceeds to step S120.

In step S111, the ECU 10 determines whether a vehicle is present before the traffic light which has been recognized as the stoppage factor. Specifically, the ECU 10 determines whether a vehicle is present on the side closer to the own vehicle 40 than a position y2 before the traffic light 42 (a position as seen in the negative direction of the y axis). In step S111, the ECU 10 determines that a vehicle is present before the traffic light 42 which has been recognized as the stoppage factor, not only if the vehicle is present inside the lane S1 but also if the vehicle is present inside a lane S2 between the white line WC and a white line WR or on the side closer to the left side of the own vehicle 40 (as seen in the negative direction of the x axis) than the white line WL. Thus, the ECU 10 makes an affirmative determination in step S111.

If the ECU 10 makes an affirmative determination in step S111, the process proceeds to step S112. In step S112, the ECU 10 determines that the notification is suppressed, and the process is ended. If the ECU 10 makes a negative determination in step S111, the process proceeds to step S113.

In step S113, the ECU 10 determines whether the preceding vehicle recognized as a stoppage factor in step S110 has been released from being the stoppage factor. When the traffic light 42 changes from the stop signal to the enabling signal (for example, green light), the traffic light 42 is released from being the stoppage factor. As a result, the ECU 10 makes an affirmative determination in step S113, and the process proceeds to step S114. For example, if the traffic light 42 recognized as a stoppage factor has not been released from being the stoppage factor due to the continuance of the stop signal, the ECU 10 makes a negative determination in step S113. The ECU 10 repeats the determination in step S 113 until the ECU 10 makes an affirmative determination.

In step S114, the ECU 10 determines whether an interfering object is present that interferes with the starting of the own vehicle. For example, as illustrated in FIG. 4, in the lane S1, the area between the position y2 before the traffic light 42 and the front end position y0 of the own vehicle 40 is set as an interfering object detection area A2. The ECU 10 determines whether an object is present in the interfering object detection area A2. If the interfering object 50 (a pedestrian in FIG. 4) is detected in the interfering object detection area A2, the ECU 10 makes an affirmative determination in step S114, and the process proceeds to step S115. In step S115, the ECU 10 determines that the notification is suppressed, and the process is ended. If no interfering object is detected in the interfering object detection area A2, the ECU 10 makes a negative determination in step S114, and the process proceeds to step S116. In step S116, the ECU 10 determines that the notification is provided, and the process is ended.

In step S120, the ECU 10 determines whether a railroad crossing having been determined to be released from being the stoppage factor is present, based on information on the objects in the surroundings of the own vehicle acquired from the camera sensor 21 and the radar sensor 22.

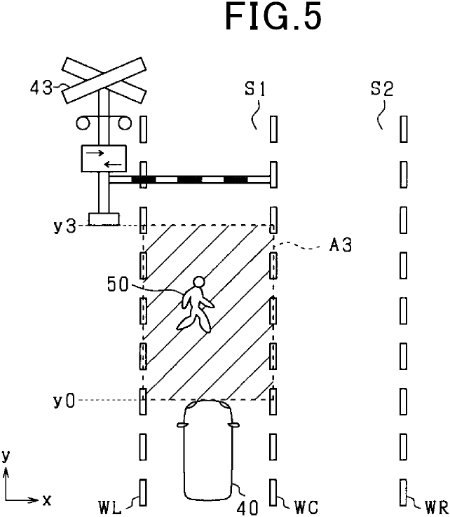

As illustrated in FIG. 5, while the own vehicle 40 is running in the lane S1 in the positive direction of the y axis, if a railroad crossing 43 indicating the stop signal (for example, the crossing bar is down) to vehicles running in the lane S1 in the traveling direction of the own vehicle 40 is present, it can be estimated that the own vehicle 40 will stop due to the stop signal indicated by the railroad crossing 43. Accordingly, the railroad crossing 43 is recognized as a stoppage factor. As a result, the ECU 10 makes an affirmative determination in step S 120, and the process proceeds to step S121. If the railroad crossing 43 recognized as a stoppage factor is not present, the ECU 10 makes a negative determination in step S120, and the process proceeds to step S124. In step S124, the ECU 10 determines that the notification is provided, and then the process is ended.

In step S121, the ECU 10 determines whether the railroad crossing recognized as a stoppage factor in step S120 has been released from being the stoppage factor. For example, referring to FIG. 5, if the signal indicated by the railroad crossing 43 is changed from the stop signal to the enabling signal (for example, the crossing bar is up), the railroad crossing 43 is released from being the stoppage factor. As a result, the ECU 10 makes an affirmative determination in step S121, and the process proceeds to step S122. If the railroad crossing 43 recognized as a stoppage factor is not released from being the stoppage factor due to the continuance of the stop signal, the ECU 10 makes a negative determination in step S121. The ECU 10 repeats the determination in step S121 until the ECU 10 makes an affirmative determination.

In step S122, the ECU 10 determines whether an interfering object is present that interferes with the starting of the own vehicle. For example, as illustrated in FIG. 5, in the lane S1, the area between a position y3 before the railroad crossing 43 and the front end position y0 of the own vehicle 40 is set as an interfering object detection area A3. The ECU 10 determines whether an object is present in the interfering object detection area A3. If the interfering object 50 (a pedestrian in FIG. 5) is detected in the interfering object detection area A3, the ECU 10 makes an affirmative determination in step S122, and the process proceeds to step S123. In step S123, the ECU 10 determines that the notification is suppressed, and the process is ended. If no interfering object is detected in the interfering object detection area A3, the ECU 10 makes a negative determination in step S123, and the process proceeds to step S124. In step S124, the ECU 10 determines that the notification is provided, and the process is ended.

As described above, in steps S103, S 113, and S121, the ECU 10 sets the determination that the stoppage factor is cleared, as the condition for permitting the provision of the notification for prompting the starting of the own vehicle 40 during the stoppage of the own vehicle 40. In addition, in steps S104, S114, and S122, the ECU 10 can make a determination on the existence of the interfering object 50 that interferes with the starting of the own vehicle 40, based on the object information of another object having not been recognized as a stoppage factor. If it is determined in steps S103, S113, and S121 that the stoppage factor is cleared during the stoppage of the own vehicle 40 but it is determined in steps S104, S114, and S122 that the interfering object 50 is present, the ECU 10 determines that the provision of the notification for prompting the starting of the own vehicle 40 is suppressed in steps S105, S115, and S123. Specifically, the ECU 10 determines that the notification that the own vehicle 40 can be started is not provided. Even if the condition for permitting the provision of the notification for prompting the starting of the own vehicle 40 is satisfied, the ECU 10 can suppress the provision of the notification for prompting the starting of the own vehicle 40, in a situation with concern that the own vehicle 40 may not be started safely due to the existence of the interfering object 50. This makes it possible to provide the notification for prompting the starting of the own vehicle 40 with consideration given to safety.

The ECU 10 is capable of recognizing the preceding vehicle 41 ahead of the own vehicle 40, or the traffic light 42 or the railroad crossing 43 being present in the traveling direction of the own vehicle 40, as stoppage factors, in steps S102, S110, or S120. The ECU 10 sets the interfering object detection area A1, A2, or A3 in the lane S1 in which the own vehicle 40 is running, based on the position of the own vehicle 40 and the position of the preceding vehicle 41, the traffic light 42, or the railroad crossing 43 recognized as a stoppage factor, respectively. The notification is suppressed if the interfering object 50 is recognized in the interfering object detection area Al, A2, or A3. This makes it possible to detect the existence of an object that is unlikely to interfere with the starting of the own vehicle 40, such as a stationary object at a long distance from the own vehicle 40, and avoid the suppression of the notification, so that the suppression and provision of the notification can be appropriately selected.

If the traffic light 42 is recognized as a stoppage factor in step S110 and if information is acquired suggesting a possibility that a vehicle may intrude into the lane S1 in which the own vehicle 40 is running on the side closer to the own vehicle 40 than the traffic light 42 in step S111, the ECU 10 determines that the stoppage factor is not cleared without the determination on whether to release the traffic light 42 from being the stoppage factor in step S113, and suppresses the notification. Accordingly, if the driver of the own vehicle 40 visually recognizes a vehicle being intruding into the lane S1 from a side road or the like and is waiting for the end of the intrusion regardless of the signal indicated by the traffic light 42, the ECU 10 can determine that the notification that the own vehicle 40 can start is not provided. As a result, it is possible to reduce driver discomfort and provide the notification for prompting the starting of the own vehicle 40 with consideration given to safety.

### Second Embodiment

In the first embodiment, as illustrated in FIGS. 3 to 5, the ECU 10 sets the interfering object detection area A1, A2, or A3 in the lane S1 in which the own vehicle 40 is running, based on the position y0 of the own vehicle 40 and the position y1, y2, or y3 of the preceding vehicle 41, the traffic light 42, or the railroad crossing 43 that has been recognized as a stoppage factor. However, the present disclosure is not limited to this. The interfering object detection area may be set based on information other than the object information of the object having been recognized as a stoppage factor.

In a second embodiment as described below, a detection area setting unit 18 can set an interfering detection area as appropriate, based on driving information on the driving state of the own vehicle, road information of the road on which the own vehicle is running, object information of an object having been recognized as a stoppage factor. The interfering object detection unit 19 may be further capable of detecting, as an interfering object, an object that is detected outside the interfering object detection area and may intrude into the interfering object detection area.

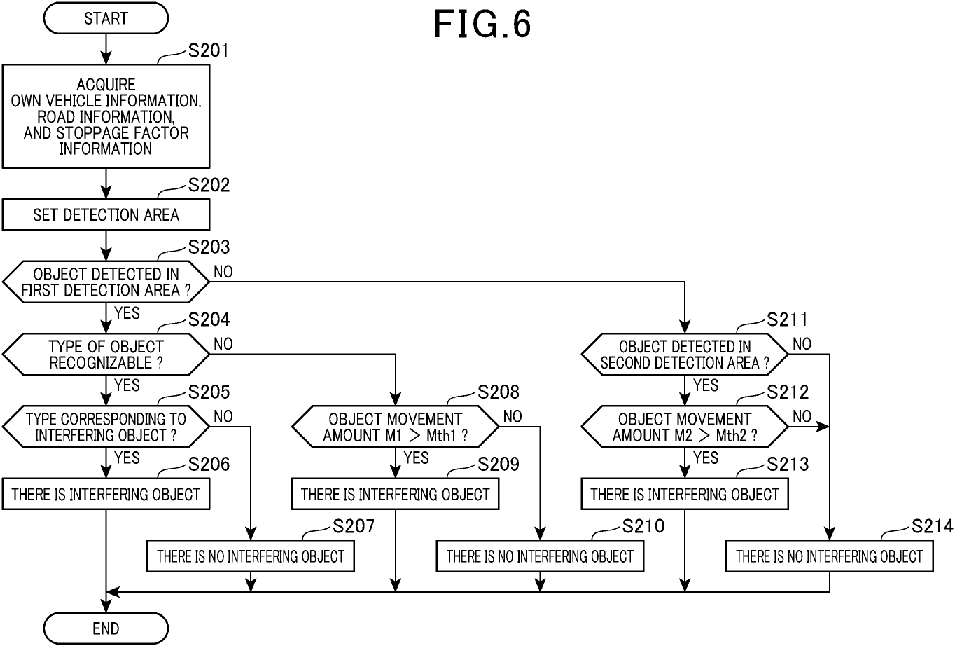

FIG. 6 is a flowchart of an interfering object determination process according to the second embodiment. The steps described in FIG. 6 are repeatedly executed in predetermined cycles. The steps described in FIG. 6 are applicable to steps S104, S114, and S122 described in FIG. 2, and can be executed by the ECU 10 illustrated in FIG. 1.

In step S201, the ECU 10 acquires the driving information on the driving state of the own vehicle, the road information of the road on which the own vehicle is running, and the object information of the object having been recognized as a stoppage factor, and the process proceeds to step S202.

In step S202, the ECU 10 sets a first detection area and a second detection area, based on at least one of the driving information, the road information, and the object information acquired in step S201. The first detection area corresponds to the interfering object detection area. The second detection area is set around the first detection area. Then, the process proceeds to step S203.

For example, the first detection area may be set using at least any one of steering angle information and yaw rate information acquired as the driving information of the own vehicle. The steering angle information can be acquired from a steering angle sensor 23, and the yaw rate information can be acquired from a yaw rate sensor 24. For example, as illustrated by arrow R in FIG. 7, if the own vehicle 40 will take a path so as not to go straight ahead in the direction of the lane S1 in which the own vehicle 40 is currently running by steering, the ECU 10 uses the steering angle of the own vehicle 40 acquired from the steering angle sensor 23 to set a first detection area A4.

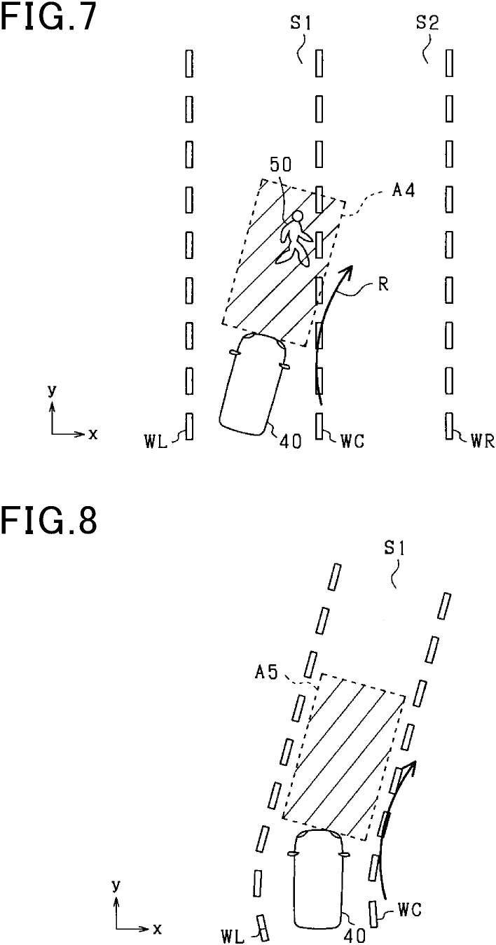

Alternatively, the ECU 10 may set the first detection area using at least any one of lane marking information (white line information), road shape information, and map information acquired as the road information of the road on which the own vehicle is running, for example. The lane marking information and the road shape information can be acquired from the camera sensor 21, and the map information can be acquired from the GNSS reception device 25. For example, as illustrated in FIG. 8, the ECU 10 sets a first detection area A5 along the lane S1, regardless of the current orientation of the own vehicle 40, at a site where the white line WL and the white line WC curve rightward and the lane S1 forms a rightward curve. As illustrated in FIGS. 7 and 8, setting the first detection area based on the driving information and the road information makes it possible to set an appropriate interfering object detection area suited to the future path of the own vehicle 40.

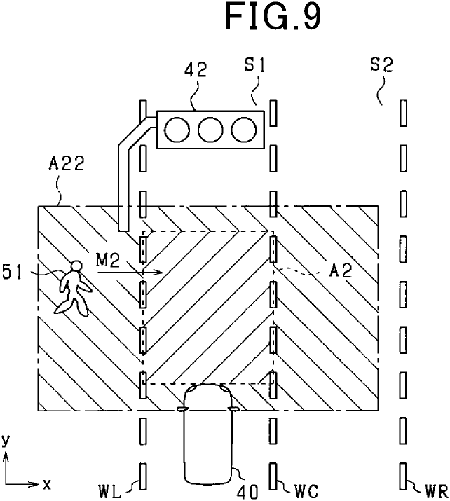

In step S202, the ECU 10 sets a second detection area for detecting an object that may intrude into the interfering object detection area, outside the interfering object detection area. For example, as illustrated in FIG. 9, the ECU 10 sets a second detection area A22 in addition to the first detection area A2. The own vehicle 40, the traffic light 42, the lane S 1, and the like illustrated in FIG. 9 are similar to those illustrated in FIG. 4, and the first detection area A2 illustrated in FIG. 9 corresponds to the first detection area A2 illustrated in FIG. 4. As illustrated in FIG. 9, the second detection area A22 is set outside the first detection area A2, adjacent to the first detection area A2 in the x axis direction and the y axis direction of the first detection area A2. The second detection area A22 is formed in a shape that surrounds the outer periphery of the first detection area A2. The second detection area A22 is set as a region that is widely extended in the x axis direction rather than in the y axis direction with respect to the first detection area A2. After the ECU 10 sets the detection areas in step S202, the process proceeds to step S203.

In steps S203 to S210, the ECU 10 makes determinations on an object detected in the first detection area. First, in step S203, the ECU 10 determines whether an object has been detected in the first detection area. If any object has been detected in the first detection area, the process proceeds to step S204. If no object has been detected in the first detection area, the process proceeds to step S211.

In step S204, the ECU 10 executes type determination on the detected object, based on the acquired object information of the object, and determines whether the type of the object has been determined. Specifically, the ECU 10 determines the type of the detected object, based on the image information acquired from the camera sensor 21 and the dictionary information prepared in advance for identification of target objects. If the type of the object has been detected, the process proceeds to step S205. If the type of the object has not been detected, the process proceeds to step S208.

In step S205, the ECU 10 determines whether the type of the object determined in step S204 is a type corresponding to an interfering object. For example, if in step S204, the ECU 10 recognizes the type of the object detected in step S203 as a pedestrian, a vehicle (including a four-wheel vehicle, a two-wheel vehicle, or the like), or a bicycle, the ECU 10 determines that the object is an interfering object in step S205, and the process proceeds to step S206. In step S206, the ECU 10 determines that “there is an interfering object”, and then the process is ended.

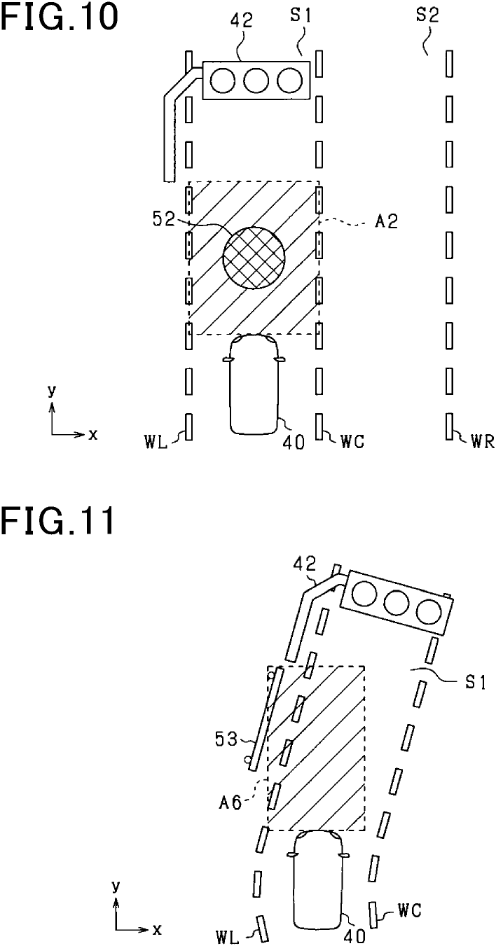

For example, if in step S204, the ECU 10 recognizes the type of the object detected in step S203 as a manhole 52 in the lane S1 as illustrated in FIG. 10 or a guard rail 53 on the road shoulder on the left side (the white line WL side) of the lane S1 as illustrated in FIG. 11, the ECU 10 determines that the object is not an interfering object in step S205, and the process proceeds to step S207. In step S207, the ECU 10 determines that “there is no interfering object”. The processing in step S203 is useful in a case where the object information detected by the camera sensor 21 is not available. In particular, it is possible to suppress metallic structures likely to be detected by the radar sensor 22, such as the manhole 52 and the guard rail 53, from being wrongly interfering objects.

On the other hand, in step S208, the ECU 10 determines whether a movement amount M1 of the object of which the type was not recognized in step S204 exceeds a predetermined movement amount threshold Mth1. For example, based on the object information acquired from the camera sensor 21 and/or the radar sensor 22, the ECU 10 can calculate, for each object, a lateral speed that is a relative speed in a direction orthogonal to the traveling direction of the own vehicle and a longitudinal speed that is a relative speed in the traveling direction of the own vehicle. Then, the ECU 10 can calculate the movement amount M1 based on the lateral speed and the longitudinal speed. The movement amount threshold Mth1 can be set to zero or so, for example. In this case, in step S208, the ECU 10 can determine whether the object of which the type was not recognized can be regarded as a stationary object. In the case of M1 > Mth1, the process proceeds to step S209. In step S209, the ECU 10 determines that “there is an interfering object”, and then the process is ended. In the case of M1 ≤ Mth1, the process proceeds to step S210. In step S210, the ECU 10 determines that “there is no interfering object”, and then the process is ended. In steps S208 to S210, if an object of which the type was not recognized can be regarded as a stationary object, the object can be handled as an object not corresponding to an interfering object. Specifically, stationary objects such as the manhole 52 in the lane S1 as illustrated in FIG. 10 and the guard rail 53 on the road shoulder on the left side (the white line WL side) of the lane S1 as illustrated in FIG. 11 can be handled as objects not corresponding to an interfering object.

In steps S211 to S214, the ECU 10 makes determinations on an object detected in the second detection area. First, in step S211, the ECU 10 determines whether an object has been detected in the second detection area. For example, as illustrated in FIG. 9, if an object 51 (a pedestrian in FIG. 9) has been detected in the second detection area A22, the ECU 10 determines that an object has been detected in the second detection area, and the process proceeds to step S212. If no object has been detected in the second detection area A22, the process proceeds to step S214. In step S214, the ECU 10 determines that “there is no interfering object”.

In step S212, the ECU 10 determines whether a movement amount M2 of the object detected in the second detection area in step S211 exceeds a predetermined movement amount threshold Mth2. The movement amount M2 can be calculated, like the movement amount M1, based on the object information acquired from the camera sensor 21 and/or the radar sensor 22, for example. The movement amount threshold Mth2 can be set as a movement amount with which the object detected in the second detection area can intrude into the first detection area. The movement amount threshold Mth2 may be set to a fixed value or may be set based on the distance between the object detected in the second detection area and the first detection area or the like.

For example, referring to FIG. 9, the movement amount M2 of the object 51 detected in the negative direction of the x axis with respect to the first detection area A2 is calculated with the direction toward the first detection area A2 (the positive direction of the x axis) as a positive direction, and is compared to the movement amount threshold Mth2 that is a positive movement amount. In the case of M2 > Mth2, the process proceeds to step S213. In step S213, the ECU 10 determines that “there is an interfering object”, and then the process is ended. In the case of M2 ≤ Mth2, the process proceeds to step S214. In step S214, the ECU 10 determines that “there is no interfering object”, and then the process is ended. In steps S211 to S214, if the object 51 is detected in the second detection area A22, when the movement amount M2 of the object 51 is large to a degree that the object 51 may intrude into the first detection area A2, the object 51 can be handled as an object corresponding to an interfering object. Thus, the ECU 10 makes an affirmative determination on the existence of an interfering object as in steps S104, S114, and S122, and the notification is suppressed. As a result, if the object 51 detected outside the interfering object detection area may intrude into the interfering object detection area, it is possible to avoid the provision of the notification, so that the notification for prompting the starting of the own vehicle 40 can be provided with more consideration given to safety. In addition, even if the setting of the interfering object detection area does not fully match the situations of the own vehicle 40 and its surroundings, it is possible to select the provision or suppression of the notification in a more reliable, safe, and appropriate manner, considering the object 51 that has been detected outside the interfering object detection area.

In the second embodiment, it is determined whether an object has been detected in the second detection area on the condition that no object has been detected in the first detection area. However, the present disclosure is not limited to this. It may be determined whether an object has been detected in the second detection area, regardless of the result of the determination on whether an object has been detected in the first detection area.

In the second embodiment, among the objects that have been detected outside the first detection area, the movement amount M2 of an object that has been detected in the second detection area is compared to the movement amount threshold Mth2 to determine whether there is a possibility that the object detected outside the interfering object detection area may intrude into the interfering object detection area. However, the present disclosure is not limited to this. For all the objects detected outside the first detection area, it may be determined whether there is a possibility that each of the objects may intrude into the interfering object detection area, without setting the second detection area.

### Modification Examples

The stoppage factor determination unit 11 may be configured to comprehensively determine whether to clear the stoppage factor, based on the results of determinations that the stoppage factor is to be cleared, made by the preceding vehicle determination unit 14, the traffic light determination unit 15, and the railroad crossing determination unit 16, respectively. For example, the stoppage factor determination unit 11 may set the priority order of the results of the determinations by the preceding vehicle determination unit 14, the traffic light determination unit 15, and the railroad crossing determination unit 16, based on the positional relationship among the objects recognized as stoppage factors by the preceding vehicle determination unit 14, the traffic light determination unit 15, and the railroad crossing determination unit 16, respectively, so that the notification determination unit 13 may utilize the maximum-priority determination result as the result of the determination by the stoppage factor determination unit 11.

Specific description will be given as to an exemplary case where, as illustrated in FIG. 12, the preceding vehicle 41 is stopped at a position on the front side (the side close to the own vehicle 40) of the traffic light 42, the preceding vehicle determination unit 14 recognizes the preceding vehicle 41 as a stoppage factor, and the traffic light determination unit 15 recognizes the traffic light 42 as a stoppage factor. In this case, the stoppage factor determination unit 11 prioritizes the result of determination by the preceding vehicle determination unit 14 over the result of determination by the traffic light determination unit 15, and determines whether the stoppage factor is cleared. Specifically, even if the traffic light determination unit 15 determines that the stoppage factor is cleared, if the preceding vehicle determination unit 14 does not determine that the stoppage factor is cleared, the stoppage factor determination unit 11 determines that the stoppage factor is not cleared. In a situation that the preceding vehicle 41 positioned in front has not been started even if the traffic light 42 has changed to the enabling signal, it is not appropriate to start the own vehicle 40. In such a situation, it is possible to suppress the provision of the notification for prompting the starting of the own vehicle 40.

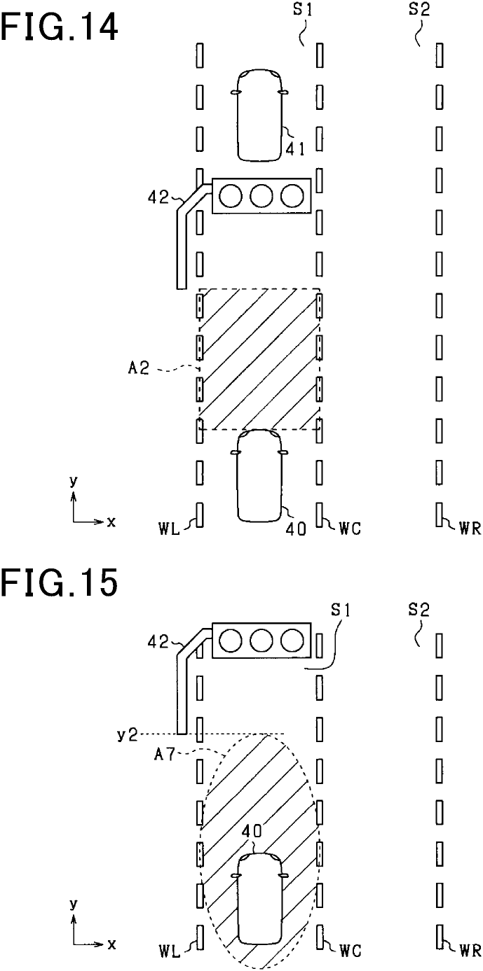

As illustrated in FIG. 14, in contrast to FIG. 12, if the preceding vehicle 41 is stopped at a position beyond the traffic light 42 (the side distant from the own vehicle 40 of the traffic light 42), and the preceding vehicle determination unit 14 recognizes the preceding vehicle 41 as a stoppage factor, and the traffic light determination unit 15 recognizes the traffic light 42 as a stoppage factor, the stoppage factor determination unit 11 prioritizes the result of the determination by the traffic light determination unit 15 over the result of the determination by the preceding vehicle determination unit 14, and determines whether to clear the stoppage factor. Specifically, even if the preceding vehicle determination unit 14 determines that the stoppage factor is cleared, if the traffic light determination unit 15 does not determine that the stoppage factor is cleared, the stoppage factor determination unit 11 determines that the stoppage factor is not cleared. In a situation where the preceding vehicle 41 is located beyond the traffic light 42, even if the preceding vehicle 41 has not been started, the own vehicle 40 can move up to the traffic light 42, and thus it is appropriate to start the own vehicle 40. In such a situation, it is possible to avoid the suppression of the notification for prompting the starting of the own vehicle 40.

The stoppage factor determination unit 11 may be capable of determining that the stoppage factor is not cleared under predetermined conditions, regardless of the results of the determinations that the stoppage factor is cleared, made by the preceding vehicle determination unit 14, the traffic light determination unit 15, and the railroad crossing determination unit 16, respectively.

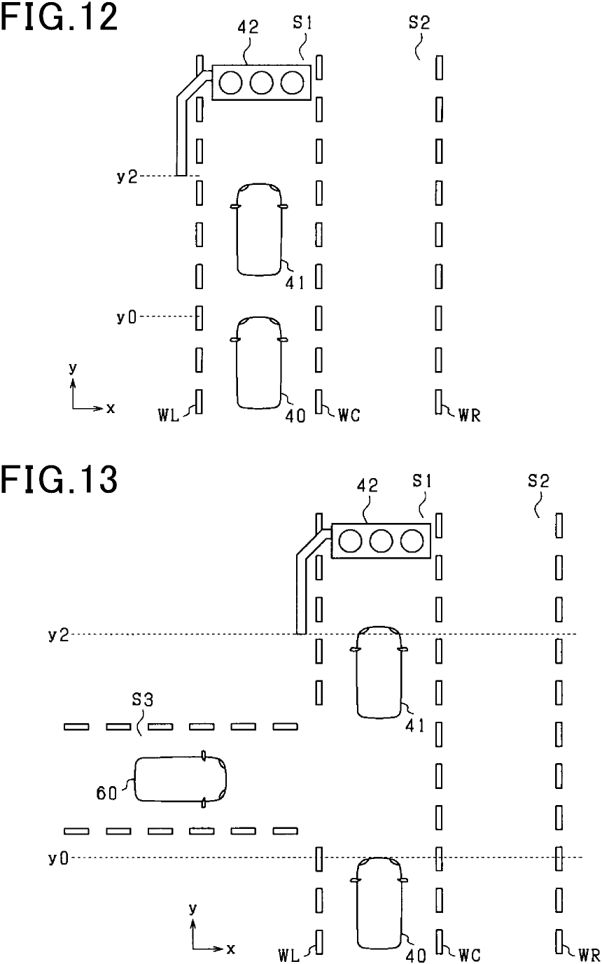

For example, as illustrated in FIG. 13, if a possibility is suggested that another vehicle 60 may intrude into the lane S1 because of the existence of a side road S3 joining into the lane S1 on the side closer to the own vehicle 40 than the traffic light 42 having been recognized as a stoppage factor by the traffic light determination unit 15, the stoppage factor determination unit 11 may be capable of determining that the stoppage factor is not cleared under predetermined conditions, without adopting the determinations that the stoppage factor is cleared, made by the preceding vehicle determination unit 14, the traffic light determination unit 15, and the railroad crossing determination unit 16, respectively. For example, referring to the flowchart in FIG. 2, an affirmative determination is made in step S111 due to the existence of the other vehicle 60 illustrated in FIG. 13, and the process proceeds to step S112 to suppress the notification. In step S111, an affirmative determination is made if a vehicle is actually present such as the other vehicle 60. Alternatively, an affirmative determination may be made if there is acquired information suggesting a possibility that a vehicle may intrude into the lane S1 in which the own vehicle 40 is running. For example, an affirmative determination may be made to suppress the notification even in a case where the side road S3 illustrated in FIG. 13 is detected but the other vehicle 60 is not detected. Besides the side road S3, in a case where the entrance/exit to/from a parking lot of a store is detected, it may be deemed that there is suggested a possibility that a vehicle may intrude into the lane S1 in which the own vehicle 40 is running.

In the foregoing embodiments, the interfering object detection area is a square area that is set in the traveling (forward) direction of the own vehicle 40 as an example, but the present disclosure is not limited to this. The interfering object detection area may be set based on the possibility of a collision between an object around the own vehicle 40 and the own vehicle 40. For example, the interfering detection area may be an interfering detection area A7 that is set in an oval shape around the own vehicle 40 as illustrated in FIG. 15. The interfering object detection area may include not only the front side of the own vehicle 40 but also the lateral sides and back side of the own vehicle 40 like the interfering detection area A7. However, since an object existing in front of the own vehicle 40 is likely to collide the own vehicle 40, it is preferred to set a wider interfering detection area on the front side of the own vehicle 40 than on the lateral sides and back side. Furthermore, the interfering detection area may extend beyond the white line WL and while line WC defining the lane S1.

In accordance with the flowchart of FIG. 2, if it is determined that there is an obstacle in front of the own vehicle after the stoppage factor has been cleared because the preceding vehicle has been started or the traffic light has turned from red to green, the notification is suppressed. Instead of this, there may be a predetermined period of waiting time until the obstacle is no longer present after the clearance of the stoppage factor. When the obstacle is no longer present, if the stoppage factor has been still cleared, the notification may be provided. In this case, if the obstacle is still present after a lapse of the predetermined period of time, the notification may be suppressed. Even if the obstacle is no longer present by a lapse of the predetermined period of time, if the stoppage factor has returned from the cleared state to the uncleared state, the notification may be suppressed. The suppression of provision of the notification conceptually includes reducing the degree of the notification to be lower than usual, for example, such as turning down a notification sound or decreasing the number of means for making a notification, if there is a plurality of means, and ceasing the provision of the notification.

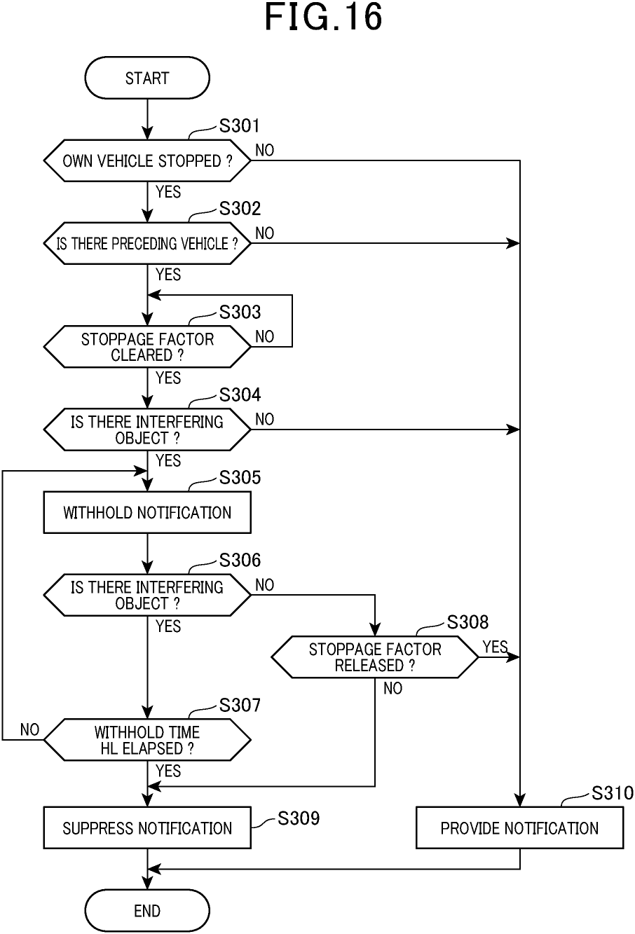

FIG. 16 is an exemplary flowchart of a notification determination process according to a modification example that will be specifically described below. The notification determination process illustrated in FIG. 16 is repeatedly executed by an ECU 10 in predetermined cycles like the notification determination process illustrated in FIG. 2.

In steps S301 to S304, as in steps S101 to S104 illustrated in FIG. 2, the ECU 10 determines whether the own vehicle is stopped, determines whether a preceding vehicle having been recognized as a stoppage factor is present, determines whether the preceding vehicle has been released from being the stoppage factor, and determines whether an interfering object is present.

If the ECU 10 makes an affirmative determination in step S304, the process proceeds to step S305. In step S305, the ECU 10 determines that the provision of the notification is withheld, the process proceeds to step S306. If the ECU 10 makes a negative determination in step S304, the process proceeds to step S310. In step S310, as in step S106 illustrated in FIG. 2, the ECU 10 determines that the notification is provided, and then the process is ended.

In step S306, the ECU 10 determines whether the object detected as an interfering object in step S304 is still an interfering object at present. For example, as illustrated in FIG. 3, if the interfering object 50 detected in the interfering object detection area A1 in step S304 is also detected in the interfering object detection area A1 in step S306, the ECU 10 makes an affirmative determination in step S306, and the process proceeds to step S307. If the object detected as the interfering object 50 is detected outside the interfering object detection area A1 in step S306, the ECU 10 makes a negative determination in step S306, and the process proceeds to step S308. In step S308, the ECU 10 determines whether an interfering object is present that interferes with the starting of the own vehicle.

In step S307, the ECU 10 determines whether a withhold time HL has elapsed in the state where the notification is withheld. Specifically, for example, the ECU 10 determines whether an elapsed time HP since the start of withholding the notification has exceeded the withhold time HL. The withhold time HL is the upper limit time for withholding the notification, which can be set in accordance with the state of the own vehicle, the state of surroundings of the own vehicle, and the like. If the withhold time HL has elapsed (for example, in the case of HP > HL), the ECU 10 makes an affirmative determination in step S307, and the process proceeds to step S309. In step S309, as in step S105 illustrated in FIG. 2, the ECU 10 determines that the notification is suppressed, and then the process is ended. If the withhold time HL has not elapsed (for example, in the case of HP ≤ HL), the ECU 10 makes a negative determination in step S307. The process returns to step S305, and the ECU 10 continues the withholding of the notification.

In step S308, the ECU 10 determines whether the preceding vehicle recognized as a stoppage factor in step S302 and then determined to be released from being the stoppage factor in step S303 is still in the state of being released from being the stoppage factor at present. For example, as illustrated in FIG. 3, if the preceding vehicle 41 has been released from being the stoppage factor due to starting from the stoppage state and then has been stopped again, the preceding vehicle 41 has returned from the state of being released from being the stoppage factor to the state of being unreleased from being the stoppage factor. Thus, the ECU 10 makes a negative determination in step S308, and the process proceeds to step S309. If, after the starting from the stoppage state, the preceding vehicle 41 continues running and remains released from being the stoppage factor, the ECU 10 makes an affirmative determination in step S308, and the process proceeds to step S310.

According to the modification example illustrated in FIG. 16, even if it is determined in step S303 that the stoppage factor is cleared during stoppage of the own vehicle 40, if the interfering object determination unit 12 determines as in steps S304 and S305 that an interfering object is present, the provision of the notification for prompting the starting of the own vehicle is withheld. As in steps S305 to S308 and S310, if it is determined that the interfering object is no longer present and it is determined that the stoppage factor has been cleared before a lapse of the withhold time HL, the notification is provided. On the other hand, as in steps S305 to S307 and S309, if the interfering object is still present even after a lapse of the withhold time HL, the provision of the notification is suppressed. As in steps S305 to S309, even if the interfering object is no longer present, if the interfering factor is not cleared before a lapse of the withhold time HL, the provision of the notification is suppressed.

As in the modification example of FIG. 16, the ECU 10 may be configured to, in a situation that there is concern about safe starting of the own vehicle judging from the results of the determination by the interfering object determination unit 12, withhold the notification for prompting the starting of the own vehicle 40 and determine whether the notification is provided or suppressed during the withhold time TL. This configuration also makes it possible to provide the notification for prompting the starting of the own vehicle 40 with consideration given to safety.

In step S306, the ECU 10 may determine whether objects other than the object detected as an interfering object in step S304 are interfering objects. In step S308, the ECU 10 may determine the stoppage factors other than the preceding vehicle recognized as a stoppage factor in step S302 have been cleared.

Withholding the provision of the notification for the predetermined withhold time HL means that the upper limit of the withhold time is the withhold time HL. For example, as in steps S305 to S310, if the withhold time HL has not yet elapsed since the start of the withholding but the ECU 10 makes a negative determination in step S306 and makes an affirmative determination in step S308, the ECU 10 may determine that the notification is provided as in step S310. On the other hand, at a point of time when the withhold time HL has elapsed since the start of the withholding, the ECU 10 may make determinations as in steps S306 and S308 and determine whether the notification is provided or suppressed.

In the modification example illustrated in FIG. 16, the process of withholding notification is applied to the notification determination process in which a preceding vehicle is recognized as a stoppage factor as in steps S102 to S106 of FIG. 2. However, the present disclosure is not limited to this. The process of withholding notification is similarly applicable to the notification determination process in which a traffic light or a railroad crossing is recognized as a stoppage factor as in steps S110 to S116 or S120 to S124.

According to the foregoing embodiments, it is possible to obtain the following advantageous effects.

The ECU 10 includes the stoppage factor determination unit 11, the interfering object determination unit 12, and the notification determination unit 13, and functions as a driving assistance device that renders driving assistance of the own vehicle 40 based on information on the objects in the surroundings of the own vehicle 40.

The stoppage factor determination unit 11 determines whether to clear a stoppage factor of the own vehicle 40, based on the object information of the object (for example, the preceding vehicle 41, the traffic light 42, or the railroad crossing 43) recognized as the stoppage factor of the own vehicle 40.

The interfering object determination unit 12 determines whether an interfering object (for example, the interfering object 50) is present that interferes with the starting of the own vehicle 40, based on the object information of another object having not been recognized as a stoppage factor. The notification determination unit 13 sets, as the condition for permitting the provision of the notification for prompting the starting of the own vehicle 40 being stopped, the determination that the stoppage factor is cleared, made by the stoppage factor determination unit 11, as in steps S103, S113, and S121, for example. The notification determination unit 13 suppresses the provision of the notification for prompting for the starting of the own vehicle, even if the stoppage factor determination unit 11 determines that the stoppage factor is cleared during the stoppage of the own vehicle 40, if the interfering object determination unit 12 determines that an interfering object is present as in steps S104, S114, and S122, for example. According to the ECU 10, it is possible to suppress the provision of the notification for prompting the starting of the own vehicle 40, even if the condition for permitting the provision of the notification for prompting the starting of the own vehicle is satisfied, if the own vehicle is in a situation where there is concern that the own vehicle may not be started safely, judging from the result of the determination by the interfering object determination unit 12. Therefore, it is possible to implement the provision of the notification for prompting the starting of the own vehicle 40 with consideration given to safety.

As described above in relation to the ECU 10, the stoppage factor determination unit 11 preferably includes at least any one of the preceding vehicle determination unit 14, the traffic light determination unit 15, and the railroad crossing determination unit 16, and more preferably includes the preceding vehicle determination unit 14 and the traffic light determination unit 15. The preceding vehicle determination unit 14 recognizes the preceding vehicle 41 ahead of the own vehicle 40 as a stoppage factor, and determines whether to clear the stoppage factor based on the object information of the preceding vehicle 41. The traffic light determination unit 15 recognizes the traffic light 42 existing in the traveling direction of the own vehicle 40 as a stoppage factor, and determines whether to clear the stoppage factor based on the object information of the traffic light 42. The railroad crossing determination unit 16 recognizes the railroad crossing 43 existing in the traveling direction of the own vehicle 40 as a stoppage factor, and determines whether to clear the stoppage factor based on the object information of the railroad crossing 43. In this case, for example, the interfering object determination unit 12 may be configured to determine that an interfering object is present, based on the object information of objects around the own vehicle 40 that is acquired from an object detection sensor (for example, the camera sensor 21 or the radar sensor 22), if another object not recognized as a stoppage factor is present between the object recognized as a stoppage factor and the own vehicle 40.

As described above in relation to the ECU 10, the interfering object determination unit 12 may include the detection area setting unit 18 and the interfering object detection unit 19. Specifically, the detection area setting unit 18 sets the interfering object detection area in which an interfering object is detected, based on the possibility of a collision between an object around the own vehicle 40 and the own vehicle 40. In this case, the interfering object detection unit 19 is preferably configured to, if another object not recognized as a stoppage factor is detected in the set interfering object detection area, determine that an interfering object is present. Detecting an interfering object in the interfering object detection area makes it possible to reduce the load of the interfering object detection process and perform an immediate determination on the notification.

The detection area setting unit 18 is preferably configured to set the interfering object detection area, based on at least one of the driving information on the driving state of the own vehicle, the road information of the road on which the own vehicle is running, and the object information of an object recognized as a stoppage factor. For example, the detection area setting unit 18 can use, as the road information for the own vehicle 40, at least any one of lane marking information, road shape information, and map information of the road on which the own vehicle is running.

The interfering object detection unit 19 may be configured to determine that an interfering object is present, if there is a possibility that the other object 51 detected outside the interfering object detection area (for example, the first detection area A2) and not recognized as a stoppage factor may intrude into the interfering object detection area. This makes it possible to avoid the provision of the notification if there is a possibility that the object 51 detected outside the interfering object detection area may intrude into the interfering object detection area, and provide the notification for prompting the starting of the own vehicle 40 with more consideration given to safety.

The interfering object detection unit 19 may be configured to, even if another object not recognized as a stoppage factor in the interfering object detection area is present, if the type of the other object is not recognizable, determine that an interfering object is present on the condition that the movement amount of the other object exceeds a predetermined movement amount threshold. This makes it possible to exclude as appropriate objects not corresponding to interfering objects, such as the manhole 52 and the guard rail 53.

The stoppage factor determination unit 11 may be configured to comprehensively determine whether to clear the stoppage factor. Accordingly, it is possible to select the provision or suppression of the notification more appropriately, in accordance with the situations of the own vehicle 40 and its surroundings. For example, the stoppage factor determination unit 11 may be configured to determine that the stoppage factor is not cleared if there is acquired information suggesting the possibility that a vehicle (for example, another vehicle 60) may intrude into the road on which the own vehicle 40 is running on the side closer to the own vehicle 40 than the traffic light 42 recognized as a stoppage factor by the traffic light determination unit 15.

For example, the stoppage factor determination unit 11 may be configured to, if the preceding vehicle 41 recognized as a stoppage factor by the preceding vehicle determination unit 14 is closer to the own vehicle 40 than the traffic light 42 recognized as a stoppage factor by the traffic light determination unit 15, prioritize the result of the determination by the preceding vehicle determination unit 14 over the result of the determination by the traffic light determination unit 15, and determine whether to clear the stoppage factor. In reverse, the stoppage factor determination unit 11 may be configured to, if the traffic light 42 recognized as a stoppage factor is closer to the own vehicle 40 than the preceding vehicle 41 recognized as a stoppage factor, prioritize the result of the determination by the traffic light determination unit 15 over the result of the determination by the preceding vehicle determination unit 14, and determine whether to clear the stoppage factor.

The notification determination unit 13 may be capable of executing a process of withholding the provision of the notification before the process of providing or suppressing the notification. For example, the notification determination unit 13 may be configured to, even if it is determined as in step S303 that the stoppage factor is cleared during the stoppage of the own vehicle 40, if the interfering object determination unit 12 determines that an interfering object is present as in steps S304 to S310, for example, withhold the provision of the notification for prompting the starting of the own vehicle for the predetermined hold time HL, and provide the notification if the interfering object is no longer present and the stoppage factor is cleared before a lapse of the withhold time HL. In this case, the notification determination unit 13 may be configured to suppress the provision of the notification, if the interfering object is still present, even if the withhold time HL has elapsed. The notification determination unit 13 may be configured to, even if the interfering object is no longer present, if the stoppage factor is not cleared before a lapse of the hold time HL, suppress the provision of the notification.

The control unit and its operations described in the present disclosure may be implemented by a dedicated computer that is provided by forming a processor programmed to execute one or more functions embodied by a computer program and a memory. Alternatively, the control unit and its operations described in the present disclosure may be implemented by a dedicated computer that is provided by forming a processor from one or more dedicated hardware logic circuits. Otherwise, the control unit and its operations described in the present disclosure may be implemented by a dedicated computer that is formed by a combination of a processor programmed to execute one or more functions and a memory and a processor formed by one or more hardware logical circuits. The computer program may be stored as instructions to be executed by the computer, in a computer-readable non-transitory tangible recording medium.

The present disclosure has been described in accordance with the embodiments, but it should be understood that the present disclosure is not limited to these embodiments and structures. The present disclosure also includes various modification examples and modifications within the scope of equivalence. In addition, various combinations and modes, and other combinations and modes including only one element of the foregoing combinations and modes, less or more than the one element, are included in the scope and conceptual range of the present disclosure.

What is claimed is:

1. A driving assistance device that renders driving assistance to an own vehicle, based on information on an object in surroundings of the own vehicle, comprising:
a stoppage factor determination unit configured to determine whether to clear a stoppage factor of the own vehicle, based on object information of an object that has been recognized as the stoppage factor of the own vehicle;
an interfering object determination unit configured to determine whether an interfering object is present that interferes with starting of the own vehicle, based on object information of another object that has not been recognized as the stoppage factor; and
a notification determination unit configured to
set, as a condition for permitting provision of a notification for prompting the starting of the own vehicle being stopped, a determination that the stoppage factor is cleared made by the stoppage factor determination unit, and
suppress the provision of the notification for prompting the starting of the own vehicle in response to the interfering object determination unit determining that the interfering object is present even if the stoppage factor determination unit determines that the stoppage factor is cleared during stoppage of the own vehicle.

2. A driving assistance device that renders driving assistance to an own vehicle, based on information on an object in surroundings of the own vehicle, comprising:
a stoppage factor determination unit configured to determine whether to clear a stoppage factor of the own vehicle, based on object information of an object that has been recognized as the stoppage factor of the own vehicle;
an interfering object determination unit configured to determine whether an interfering object is present that interferes with starting of the own vehicle, based on object information of another object that has not been recognized as the stoppage factor; and
a notification determination unit configured to
set, as a condition for permitting provision of a notification for prompting the starting of the own vehicle being stopped, a determination that the stoppage factor is cleared made by the stoppage factor determination unit, and
withhold the provision of the notification for prompting the starting of the own vehicle for a predetermined withhold time in response to the interfering object determination unit determining that the interfering object is present even if the stoppage factor determination unit determines that the stoppage factor is cleared during stoppage of the own vehicle, and provide the notification in response to the interfering object being no longer present and the stoppage factor being cleared before a lapse of the predetermined withhold time.

3. The driving assistance device according to claim 2, wherein the notification determination unit is configured to suppress the provision of the notification in response to the interfering object still being present even after a lapse of the withhold time.

4. The driving assistance device according to claim 3, wherein the notification determination unit is configured to suppress the provision of the notification in response to the interfering factor being not cleared even if the interfering object is no longer present before a lapse of the withhold time.

5. The driving assistance device according to claim 1, wherein
the stoppage factor determination unit includes at least one of:
a preceding vehicle determination unit configured to recognize a preceding vehicle ahead of the own vehicle as the stoppage factor, and determine whether to clear the stoppage factor based on object information of the preceding vehicle;
a traffic light determination unit configured to recognize a traffic light that is present in a traveling direction of the own vehicle as the stoppage factor, and determine whether to clear the stoppage factor based on object information of the traffic light; and
a railroad crossing determination unit configured to recognize a railroad crossing that is present in the traveling direction of the own vehicle as the stoppage factor, and determine whether to clear the stoppage factor based on object information of the railroad crossing, and
the interfering object determination unit is configured to determine that the interfering object is present, based on object information of an object around the own vehicle that is acquired from an object detection sensor, in response to another object not recognized as the stoppage factor being present between the object recognized as the stoppage factor and the own vehicle.

6. The driving assistance device according to claim 2, wherein
the stoppage factor determination unit includes at least one of:
a preceding vehicle determination unit configured to recognize a preceding vehicle ahead of the own vehicle as the stoppage factor, and determine whether to clear the stoppage factor based on object information of the preceding vehicle;
a traffic light determination unit configured to recognize a traffic light that is present in a traveling direction of the own vehicle as the stoppage factor, and determine whether to clear the stoppage factor based on object information of the traffic light; and
a railroad crossing determination unit configured to recognize a railroad crossing that is present in the traveling direction of the own vehicle as the stoppage factor, and determine whether to clear the stoppage factor based on object information of the railroad crossing, and
the interfering object determination unit is configured to determine that the interfering object is present, based on object information of an object around the own vehicle that is acquired from an object detection sensor, in response to another object not recognized as the stoppage factor being present between the object recognized as the stoppage factor and the own vehicle.

7. The driving assistance device according to claim 1, wherein the interfering object determination unit includes:
a detection area setting unit configured to set an interfering object detection area in which the interfering object is detected, based on a possibility of a collision between an object around the own vehicle and the own vehicle; and
an interfering object detection unit configured to determine that the interfering object is present in response to another object which has not been recognized as the stoppage factor being detected in the interfering object detection area.

8. The driving assistance device according to claim 2, wherein the interfering object determination unit includes:
a detection area setting unit configured to set an interfering object detection area in which the interfering object is detected, based on a possibility of a collision between an object around the own vehicle and the own vehicle; and
an interfering object detection unit configured to determine that the interfering object is present in response to another object which has not been recognized as the stoppage factor being detected in the interfering object detection area.

9. The driving assistance device according to claim 7, wherein the detection area setting unit is configured to set the interfering object detection area, based on at least one of driving information on driving state of the own vehicle, road information of a road on which the own vehicle is running, and the object information of an object having been recognized as the stoppage factor.

10. The driving assistance device according to claim 8, wherein the detection area setting unit is configured to set the interfering object detection area, based on at least one of driving information on driving state of the own vehicle, road information of a road on which the own vehicle is running, and the object information of an object having been recognized as the stoppage factor.

11. The driving assistance device according to claim 9, wherein the detection area setting unit is configured to set the interfering object detection area, using at least any one of steering angle information and yaw rate information, as the driving information of the own vehicle.

12. The driving assistance device according to claim 9, wherein the detection area setting unit is configured to set the interfering object detection area, using at least any one of lane marking information, road shape information, and map information of the road on which the own vehicle is running, as the road information.

13. The driving assistance device according to claim 7, wherein the interfering object detection unit is configured to determine that the interfering object is present in response to there being a possibility that another object detected outside the interfering object detection area and not recognized as the stoppage factor may intrude into the interfering object detection area.

14. The driving assistance device according to claim 8, wherein the interfering object detection unit is configured to determine that the interfering object is present in response to there being a possibility that another object detected outside the interfering object detection area and not recognized as the stoppage factor may intrude into the interfering object detection area.

15. The driving assistance device according to claim 7, wherein the interfering object detection unit is configured to determine that the interfering object is present on a condition that movement amount of another object not recognized as a stoppage factor exceeds a predetermined movement amount threshold, in response to type of the another object being not recognizable even if the another object is present in the interfering object detection area.

16. The driving assistance device according to claim 5, wherein
the stoppage factor determination unit includes a traffic light determination unit configured to recognize a traffic light that is present in the traveling direction of the own vehicle as the stoppage factor, and determine whether to clear the stoppage factor based on the object information of the traffic light, and
the stoppage factor determination unit is configured to determine that the stoppage factor is not cleared in response to the traffic light determination unit having acquired information suggesting a possibility that a vehicle may intrude into the road on which the own vehicle is running on a side closer to the own vehicle than the traffic light recognized as the stoppage factor.

17. The driving assistance device according to claim 6, wherein
the stoppage factor determination unit includes a traffic light determination unit configured to recognize a traffic light that is present in the traveling direction of the own vehicle as the stoppage factor, and determine whether to clear the stoppage factor based on the object information of the traffic light, and
the stoppage factor determination unit is configured to determine that the stoppage factor is not cleared in response to the traffic light determination unit having acquired information suggesting a possibility that a vehicle may intrude into the road on which the own vehicle is running on a side closer to the own vehicle than the traffic light recognized as the stoppage factor.

18. The driving assistance device according to claim 5, wherein
the stoppage factor determination unit includes:
a preceding vehicle determination unit configured to recognize a preceding vehicle ahead of the own vehicle as the stoppage factor, and determine whether to clear the stoppage factor based on the object information of the preceding vehicle; and
a traffic light determination unit configured to recognize a traffic light that is present in the traveling direction of the own vehicle as the stoppage factor, and determine whether to clear the stoppage factor based on the object information of the traffic light, and
the stoppage factor determination unit is configured to, in response to the preceding vehicle recognized as the stoppage factor by the preceding vehicle determination unit being closer to the own vehicle than the traffic light recognized as the stoppage factor by the traffic light determination unit, prioritize a result of the determination by the preceding vehicle determination unit over a result of the determination by the traffic light determination unit and determine whether to clear the stoppage factor.

19. The driving assistance device according to claim 6, wherein
the stoppage factor determination unit includes:
a preceding vehicle determination unit configured to recognize a preceding vehicle ahead of the own vehicle as the stoppage factor, and determine whether to clear the stoppage factor based on the object information of the preceding vehicle; and
a traffic light determination unit configured to recognize a traffic light that is present in the traveling direction of the own vehicle as the stoppage factor, and determine whether to clear the stoppage factor based on the object information of the traffic light, and
the stoppage factor determination unit is configured to, in response to the preceding vehicle recognized as the stoppage factor by the preceding vehicle determination unit being closer to the own vehicle than the traffic light recognized as the stoppage factor by the traffic light determination unit, prioritize a result of the determination by the preceding vehicle determination unit over a result of the determination by the traffic light determination unit and determine whether to clear the stoppage factor.

20. The driving assistance device according to claim 5, wherein
the stoppage factor determination unit includes:
a preceding vehicle determination unit configured to recognize a preceding vehicle ahead of the own vehicle as the stoppage factor, and determine whether to clear the stoppage factor based on the object information of the preceding vehicle; and
a traffic light determination unit configured to recognize a traffic light that is present in the traveling direction of the own vehicle as the stoppage factor, and determine whether to clear the stoppage factor based on the object information of the traffic light, and
the stoppage factor determination unit is configured to, in response to the traffic light recognized as the stoppage factor by the traffic light determination unit being closer to the own vehicle than the preceding vehicle recognized as the stoppage factor by the preceding vehicle determination unit, prioritize a result of the determination by the traffic light determination unit over a result of the determination by the preceding vehicle determination unit and determine whether to clear the stoppage factor.
